(19) United States
(12) Patent Application Publication
(10) Pub. No.: US 2014/0238509 A1
(43) Pub. Date: Aug. 28, 2014

(54) CYLINDER VALVE FOR PRESSURIZED GAS CYLINDER AND A GAS CYLINDER COMPRISING SUCH A VALVE

(71) Applicant: L'Air Liquide, Société Anonyme pour l'Etude et l'Exploitation des Procédés Georges Claude, Paris (FR)

(72) Inventors: Marco Arzenton, Verona (IT); Silvano Bendazzoli, Verona (IT); Ivan Pezzo, San Martino Buon Albergo (IT)

(73) Assignee: L'Air Liquide, Société Anonyme pour l'Etude et l'Exploitation des Procédés Georges Claude, Paris (FR)

(21) Appl. No.: 14/193,080

(22) Filed: Feb. 28, 2014

(30) Foreign Application Priority Data
Feb. 28, 2013 (EP) 13305230.8

(51) Int. Cl. G05D 16/06; G05D 7/01

(52) U.S. Cl. CPC G05D 16/0655; G05D 7/0113
USPC 137/505.37; 137/505.47

(57) ABSTRACT

A cylinder valve comprising a body including a mounting end for attachment in the opening of a pressurized fluid cylinder, a internal withdrawing circuit comprising a first end located at the mounting end and a second end located at an outlet port located in the body, the withdrawing circuit comprising, an isolation valve and a regulating device for regulating selectively the flowrate and/or the pressure of the fluid flowing in the withdrawing circuit, the isolation valve and the regulating device being controlled by manual actuating organ(s) located on the body, the actuating organ(s) controlling the regulating device being mobile relative to the body between a first position setting a flow rate or a regulated pressure to defined minimum value and at least a second position setting a flow rate or a regulated pressure to a defined maximum value.

### CROSS REFERENCE TO RELATED APPLICATIONS

This application claims the benefit of priority under 35 U.S.C. §119 (a) and (b) to European Patent Application No. 13305230.8, filed Feb. 28, 2013, the entire contents of which are incorporated herein by reference.

### BACKGROUND

The invention concerns a cylinder valve and a cylinder comprising such a valve.

### SUMMARY

The invention deals more particularly a cylinder valve comprising a body including a mounting end for attachment in the opening of a pressurized fluid cylinder, a internal withdrawing circuit comprising a first end located at the mounting end and a second end located at an outlet port located in the body, the withdrawing circuit comprising, an isolation valve and a regulating device for regulating selectively the flowrate and/or the pressure of the fluid flowing in the withdrawing circuit, the isolation valve and the regulating device being controlled by manual actuating organ(s) located on the body, the actuating organ(s) controlling the regulating device being mobile relative to the body between a first position setting a flow rate or a regulated pressure to defined minimum value and at least a second position setting a flow rate or a regulated pressure to a defined maximum value.

Some industrial or medical cylinder valves comprise a regulation device for permitting the user to adjust the pressure and/or the flow rate of the withdrawn gas.

Those regulation devices (pressure regulator and/or flow regulators) might be integrated or mounted on the cylinder valve.

Those cylinders valves include generally an isolation valve actuated by a manual actuating organ (a hand wheel or a pivoting lever for example). The regulating device is actuated manually by another actuating organ (a distinct handwheel or pivoting lever).

Those cylinder valves are well adapted for application needing gas withdrawals on continuous long periods (for example several minutes or hours).

The user should thus first open the isolation valve by means of corresponding actuating organ and then actuate the actuating organ of the regulation device to the desired value.

However, some applications need only small quantities of gas delivered in successive short periods (for example few seconds every minute). This special gas needs might lead to a different use of the cylinder valve. For example some users set first the actuating organ (handwheel) controlling the pressure regulator and later open or close repeatedly the isolation valve. That is to say: the regulation device is preset by the corresponding actuating organ and remains unchanged during use (when isolation valve is open) and even after use (when isolation valve is closed).

This way of using the cylinder valve is contrary to the safety rules of the cylinder valves.

This kind of use generates fatigue and wear problems on the shut-off mechanism (especially in integrated systems).

In addition, this kind of use increases security risks because adiabatic compression or an unwanted high pressure may happen in the circuit.

Moreover, this use increases the risk of an accidental leak with and emptying of the cylinder.

One objective of the present invention is to solve at least partially one of the problems above mentioned.

To this goal, the cylinder valve according to the invention, in other respects in accordance to the generic definition given by the above preamble, is essentially characterized in that the cylinder valve comprises a return organ urging by default the actuating organ controlling the regulating device toward its first position.

Furthermore, embodiments might include on or several of the features below:
the isolation valve and the regulating device are separate, independent and arranged in series in the withdrawing circuit,
the isolation valve and the regulating device are controlled by distinct and respective manual actuating organ(s) located on the body, the actuating organ controlling the isolation valve being mobile relative to the body between a position urging the opening of the isolation valve (6) and an position urging the isolation valve in its closed position,
the isolation valve is controlled by the actuating organ controlling the regulating device, that is to say the isolation valve and the regulating device are controlled by a single and common manual actuating organ located on the body,
the isolation valve consists in the regulating device, that is to say, the regulating device itself selectively acts as an isolation valve for selectively closing the withdrawing circuit when the actuating organ is in its first position,
the actuating organ controlling the regulating device comprises a handwheel mounted rotating on the body,
the return organ comprises a spring having a first end connected to the actuating organ controlling the regulating device and a second end connected to a fixed part of the body,
the return organ comprises a wire coiled spring, notably a spiral or helical shaped spring,
the actuating organ controlling the regulating device comprises a concave portion facing the body, the return organ being housed into said concave portion,
the actuating organ controlling the isolation valve and the actuating organ controlling the regulating device are located respectively on different faces of the body an preferably on opposite faces of the body,
the regulating device comprises a flow rate controller for controlling and setting the flow rate of fluid into the withdrawing circuit at an adjustable level,
in its first position, the actuating organ controlling the regulating device sets a flowrate equal to zero, that is to say the regulating device closes the withdrawing circuit,
the regulation device comprises an adjustable pressure regulator for lowering the pressure of the withdrawn gas to a determined value,
the actuating organ controlling the isolation valve comprises a handwheel and/or a pivoting lever,
the withdrawing circuit comprises a residual pressure valve located between the regulation device and the isolation valve,
the body comprises an internal filling circuit comprising a first end coming out at a filling port located on the body and a second end coming out at the mounting end of the body,
the withdrawing circuit comprises a pressure relief valve,
when the actuating effort on the actuating organ controlling the regulating device toward its second position is below a torque included in the range between zero and 50 Nm (in case of couple); or below a force included in the range between zero and 500 N (in case of force); the return organ moves automatically said actuating organ in its first position,

The invention may also concern a pressurized fluid cylinder comprising a cylinder valve according to any of the above or below features.

The invention may also concern any device or method comprising any combination of features below of above mentioned.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers. Other features and advantages will be apparent to the reading of the below description, made with reference to the drawings wherein:

FIG. 1 depicts a perspective view of a possible example of cylinder valve according to the invention,

FIG. 2 depicts a perspective and partially exploded view of the cylinder valve of FIG. 1,

FIG. 3 depicts a perspective and partial view of a detail of the cylinder valve of FIG. 1 showing the internal structure of an actuating organ,

FIG. 4 depicts schematically a possible structure of the internal circuit of the cylinder valve embodying the invention and mounted on a cylinder.

FIGS. 5 and 6 depict respectively face views of two different possible embodiments of the return organ of the actuating organ of the cylinder valve according to an example of the invention.

FIG. 7 illustrates another embodiment with the isolation valve 6 and the regulating device 7 (which are separate entities) controlled by a single and common actuating organ 17 which is the actuating organ 17 controlling regulating device 7 (urged by the return organ 8).

FIG. 8 depicts a further embodiment with no separate isolation valve where the isolation valve function (closing/opening the circuit 4) is performed by the regulating device 7 itself and controlled by the actuating organ 17.

### DESCRIPTION OF PREFERRED EMBODIMENTS

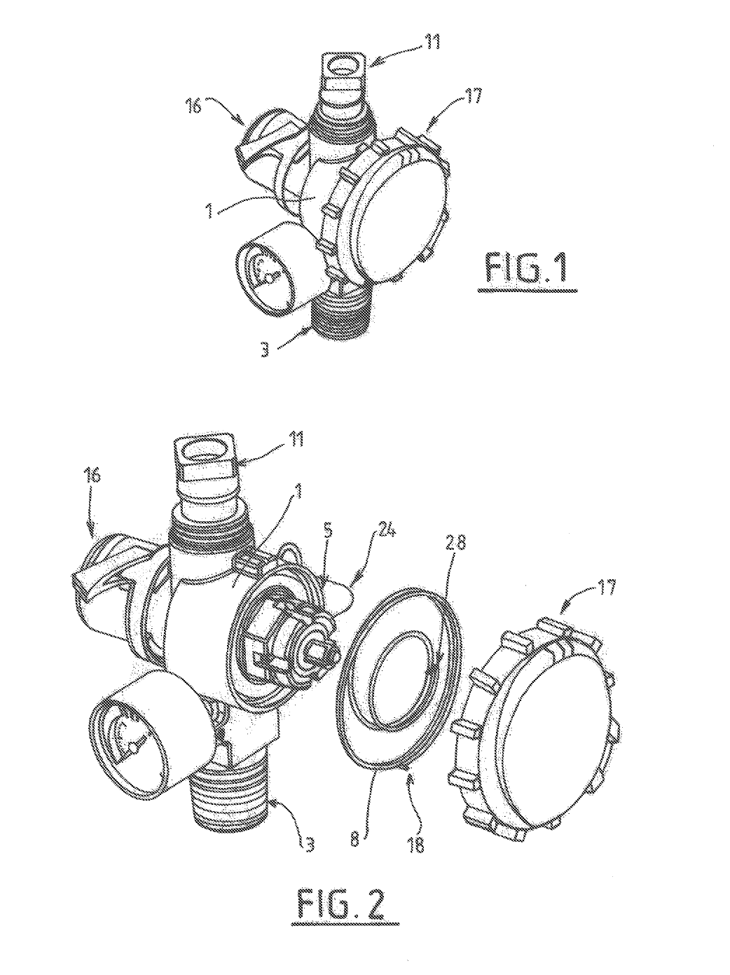

The cylinder valve shown as a non limitative example on FIG. 1 comprises a body 1 including a mounting end 3 (for example threaded) for mounting in a pressurized gas cylinder 2 opening (see for example FIG. 4).

The body 1 contains an internal withdrawing circuit 4 comprising a first end 14 located at the mounting end 3 and a second end 24 located at an outlet port 5 on the body 1.

The withdrawing circuit 4 comprises, arranged in series, an isolation valve 6 and a regulating device 7 for regulating selectively the flow rate and/or the pressure of the fluid flowing in the withdrawing circuit 4.

The regulating device 7 may include, for example, at least one among: a pressure regulator for lowering the fluid's pressure to a preset and adjustable level, a flow rate regulator for setting the fluid flow rate at a preset and adjustable value.

The isolation valve 6 and the regulating device 7 are distinct, independent and manually controlled by different and respective actuating organs 16, 17 located on the body 1. That is to say: the isolation valve 6 is controlled by its actuating organ 16 independent from the actuating organ 17 of the regulating device 7 and vice and versa.

Preferably, the actuating organs 16, 17 of the isolation valve 6 and the regulating device 7 are located respectively on different faces of the body and notably opposite faces (see FIG. 1).

The actuating organ 16 controlling the isolation valve 6 is mobile relative to the body 1 between a position opening said isolation valve and another position closing said isolation valve 6.

In this example, the isolation valve's 6 actuating organ 16 comprises a handwheel mounted rotative on the body 1 and having a knob to be grasped by the user.

Of course, the actuating organ 16 may have a different structure, for example it may comprise a pivoting lever on the body and/or a button mobile in translation on the body 1.

The actuating organ 17 controlling the regulating device 7 is mobile relative to the body 1 between a first position setting a minimal pressure or flow rate (for example a flow rate equal to zero corresponding to a closing of the circuit 4) and a second position setting a maximal pressure flow rate (depending on the pressure in the cylinder). Preferably, between its first and second positions the actuating organ 17 sets intermediate flow rates or intermediate pressures (in a discrete or continuous way).

As disclosed on FIG. 1, the actuating organ 17 comprises for example a rotative handwheel. Of course, again, this actuating organ 17 controlling the regulating device 7 may comprise another structure, for example a pivoting lever or a button mobile in translation.

According to advantageous feature, the cylinder valve comprises a return organ 8 urging by default the regulating device's actuating organ 17 toward its first position.

The return organ comprises, for example, a spring having a first end 18 linked to the regulating organ's actuating organ 17 and a second end 28 linked to a fixed part of the body 1.

For example, when the actuation effort on the actuating organ 17 of the regulating organ 7 toward its second position is below:
a torque included in the range between zero to fifty Newtonmeter (in case of couple);
a force included in the range between zero to five hundred Newton (in case of force);
the return organ 8 automatically moves the actuating organ 17 in its first position.

That is to say the user must keep its effort on the actuating organ 17 in order to maintain a determined command of flow rate/pressure. If not, the flow rate/pressure will be moved automatically to the minimum value set (closure of the withdrawing circuit by the regulating device 8).

This feature thus forces the user to use the cylinder valve in a correct and safe way because maintaining a flow rate/pressure needs a continuous manual action which intensity is at least equal to the taring force of the return organ 8.

This generates the following advantages:
lowering the risk of bad use as described above,
leak risks lowering,
a better control ergonomic for the user,
improvement of the safety due to: a longer transient phase to achieve the outlet working pressure and flow, and an opening of the actuating organ 16 with the actuating organ 17 closed.

In addition, this maintained effort of the user on the actuating organ 17 in order to get a gas flow rate and its automatic closure in case of stop increases the security of the use of the gas, especially in case of urgency or accident.

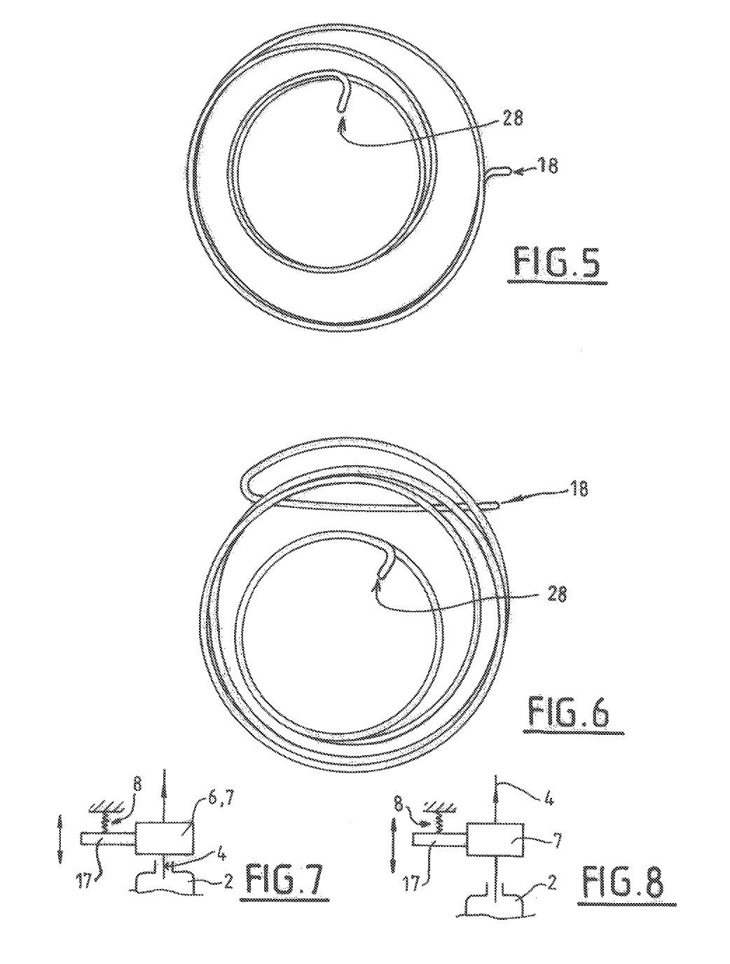

As illustrated on FIGS. 2, 3, 5 and 6, the return organ 8 comprises for example a wired coiled spring, notably of spiral or helical type. Of course, every other type of spring arrangement is possible (traction spring, compression spring, leaf spring . . . ) in order to carry out this function of urging this actuating organ 17 toward its first position.

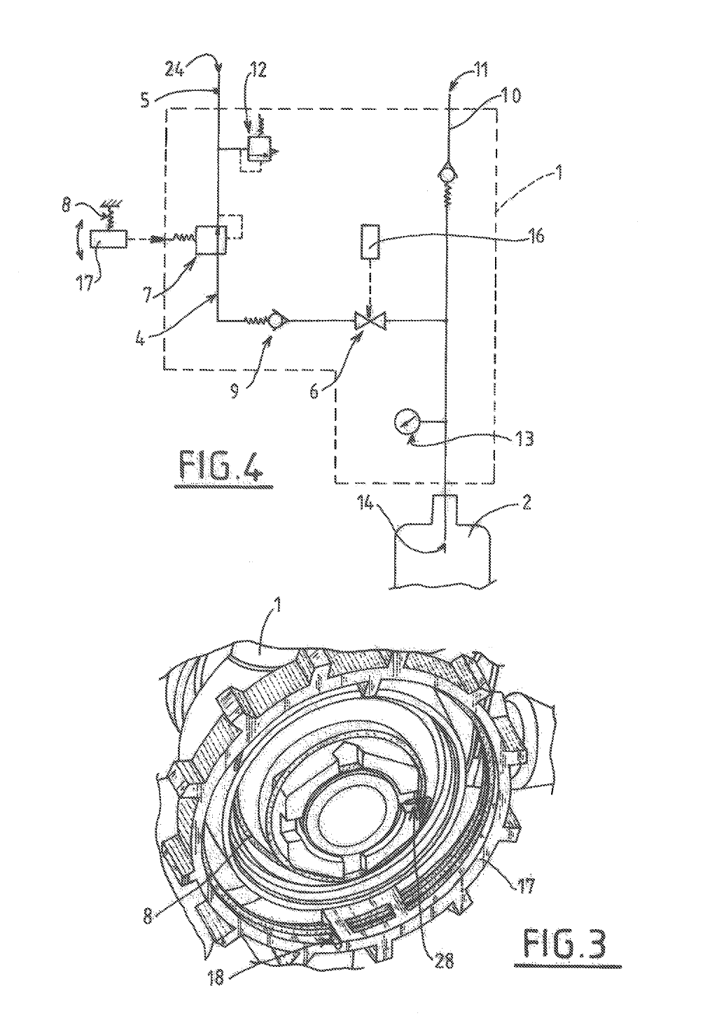

As shown on FIG. 3 (where actuating organ 17 is shown open in its central part), the actuating organ 17 comprises a concave portion facing the body 1 and the return organ is housed into this concave portion.

The extremities 18, 28 of the return organ 8 are for example located in slits or against abutments on the body and on the actuating organ 7.

As illustrated on FIG. 4 as non limitative example, the withdrawing circuit can include a residual pressure valve 9 located between the isolation valve 6 and the regulating device 7.

The withdrawing circuit 4 can include also a gauge 13 and a pressure relief valve 12 in case of failure (overpressure, overheating).

The body 1 comprises preferably also an internal filling circuit 10 having a first end located in a filling port 11 and a second end located at the mounting end 3.

Of course, the invention is not limited to the example described with references to FIGS. 1 to 6.

For example, in another embodiment illustrated at FIG. 7, the isolation valve 6 and the regulating device 7 (which are separate entities) are controlled by a single and common actuating organ 17 which is the actuating organ 17 controlling regulating device 7 (urged by the return organ 8). For example, the single actuating organ 17 controlling both the isolation valve 6 and the regulating device 7 closes the isolation valve 6 in its first position (or in another special position) and opens the isolation valve 6 in the other positions corresponding to regulated pressures or flows not null. The actuating organ 17 may also be mobile according to different movements and the opening/closing of the isolation valve 6 may be controlled by a movement different from the movement controlling the regulating device 7 (for example translation versus a rotation).

In a further embodiment illustrated at FIG. 8, there is no separate isolation valve. That is to say the isolation valve function (closing/opening the circuit 4) is performed by the regulating device 7 itself and controlled by the actuating organ 17. This means that the regulating 7 device comprises a pressure/flow regulator valve which is used also as an isolation valve. As explained earlier, the actuating organ 17 may also be mobile according to different movements and the opening/closing of circuit function may be controlled by a movement different from the movement controlling the regulating device 7 (for example translation versus rotation). Alternatively, the closing of the circuit 4 is performed when the actuating organ 17 is in its first position.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A cylinder valve comprising a body (1) including a mounting end (3) for attachment in the opening of a pressurized fluid cylinder (2), a internal withdrawing circuit (4) comprising a first end (14) located at the mounting end (3) and a second end (24) located at an outlet port (5) located in the body (1), the withdrawing circuit (4) comprising, an isolation valve and a regulating device (7) for regulating selectively the flowrate and/or the pressure of the fluid flowing in the withdrawing circuit (4), the isolation valve and the regulating device (7) being controlled by manual actuating organ(s) (16, 17) located on the body (1), the actuating organ(s) (17) controlling the regulating device (7) being mobile relative to the body (1) between a first position setting a flow rate or a regulated pressure to defined minimum value and at least a second position setting a flow rate or a regulated pressure to a defined maximum value, wherein the cylinder valve comprises a return organ (8) urging by default the actuating organ (17) controlling the regulating device (7) toward its first position, the return organ (8) comprising a spring having a first end (18) connected to the actuating organ (17) controlling the regulating device (7) and a second end connected to a fixed part of the body (1).

2. The cylinder valve according to claim 1, wherein the isolation valve (6) and the regulating device (7) are separate, independent and arranged in series in the withdrawing circuit (4).

3. The cylinder valve according to claim 2, wherein the isolation valve (6) and the regulating device (7) are controlled by distinct and respective manual actuating organ(s) (16, 17) located on the body (1), the actuating organ (16) controlling the isolation valve (6) being mobile relative to the body between a position urging the opening of the isolation valve (6) and an position urging the isolation valve (6) in its closed position.

4. The cylinder valve according to claim 1, wherein the isolation valve is controlled by the actuating organ (17) controlling the regulating device (7), that is to say the isolation valve (6) and the regulating device (7) are controlled by a single and common manual actuating organ (17) located on the body (1).

5. The cylinder valve according to claim 1, wherein the isolation valve consists in the regulating device (7), that is to say, the regulating device (7) itself selectively acts as an isolation valve for selectively closing the withdrawing circuit (4) when the actuating organ (17) is in its first position.

6. The cylinder valve according to claim 1, wherein the actuating organ (17) controlling the regulating device (7) comprises a handwheel mounted rotating on the body (1).

7. The cylinder valve according to claim 1, wherein the return organ (8) comprises a wire coiled spring, notably a spiral or helical shaped spring.

8. The cylinder valve according to claim 1, wherein the actuating organ (17) controlling the regulating device (7) comprises a concave portion facing the body (1), the return organ (8) being housed into said concave portion.

9. The cylinder valve according to claim 3, wherein the actuating organ (16) controlling the isolation valve (6) and the actuating organ (17) controlling the regulating device (7) are located respectively on different faces of the body (1) an preferably on opposite faces of the body (1).

10. The cylinder valve according to claim 1, wherein the regulating device (7) comprises a flow rate controller for controlling and setting the flow rate of fluid into the withdrawing circuit (4) at an adjustable level.

11. The cylinder valve according to claim 1, wherein, in its first position, the actuating organ (17) controlling the regulating device (7) sets a flowrate equal to zero, that is to say the regulating device (7) closes the withdrawing circuit (4).

12. The cylinder valve according to claim 1, wherein, the regulation device (7) comprises an adjustable pressure regulator for lowering the pressure of the withdrawn gas to a determined value.

13. The cylinder valve according to claim 3, wherein the actuating organ (16) controlling the isolation valve (6) comprises a handwheel and/or a pivoting lever.

14. The cylinder valve according to claim 1, wherein when the actuating effort on the actuating organ controlling the regulating device toward its second position is below a torque included in the range between zero and 50 Nm (in case of couple); or below a force included in the range between zero and 500 N (in case of force); the return organ moves automatically said actuating organ in its first position.

15. A pressurized fluid cylinder comprising a cylinder valve according to claim 1.
